(19) United States
(12) Patent Application Publication
(10) Pub. No.: US 2012/0000306 A1
(43) Pub. Date: Jan. 5, 2012

(54) BALL SCREW WITH A BUFFERING CIRCULATION MEMBER

(75) Inventors: Yan-Yu CHEN, Taichung (TW); Michelle Wu, Taichung (TW)

(73) Assignee: Hiwin Technologies Corp.

(21) Appl. No.: 13/236,135

(22) Filed: Sep. 19, 2011

Related U.S. Application Data
(63) Continuation-in-part of application No. 12/329,627, filed on Dec. 7, 2008.

(51) Int. Cl. F16H 25/22

(52) U.S. Cl. 74/424.86

(57) ABSTRACT

A ball screw with a buffering circulation member comprises: a screw, a nut, a circulation member, a plurality of rolling elements and a plurality of flexible members. The circulation member comprises a first structure and a second structure. The flexible members are disposed at the combining portion between the circulation member and the nut to allow the first and second structures to be assembled more closely in a seamless manner. The flexible members which support the circulation member can absorb or buffer the collision of the rolling elements, thus reducing the vibration of the rolling elements or the noise caused by the collision of the rolling elements.

This application is a continuation of part of U.S. patent application Ser. No. 12/329,627, which claims the benefit of the earlier filing date of Dec. 7, 2008. Claim 1 of this application is revised from claim 1 of the U.S. patent application Ser. No. 12/329,627, and claims 2-5 of this application are new.

### BACKGROUND OF THE INVENTION

1. Field of the Invention

The present invention relates to a ball screw, and more particularly to a ball screw with a circulation member.

2. Description of the Prior Art

The ball screws used on various types of machines are generally divided into internal circulation type and external circulation type. For example, U.S. Pat. No. 4,953,419 discloses an external circulation type ball screw, the circulation member of which is a reverse U-shaped pipe. However, for weight reduction of the ball screw and smooth rolling of the balls, the circulation path inside the pipe is difficult to control due the machining of the reverse U-shaped pipe is not easy. Therefore, it is impossible for the balls to move smoothly.

Outer circulation type ball screw is essentially provided with a circulation member outside the screw for guiding the rolling balls out of the nut. With the circulation member, the circulation of the rolling balls can be realized. The present invention is aimed at the assembly relation between the circulation member and the ball screw.

The existing circulation members are mostly made of plastic. After a circulation member is assembled onto the ball screw, the plastic material of the circulation member plus the inherent manufacturing tolerance of the two will make the assembly clearance between the circulation member and the ball screw inconsistent, thus reducing the defective rate of the products. Therefore, a JP 2005-61608, as shown in FIG. 1, discloses a circulation member 11 which is defined in its leg portion 111 with a groove 112 for mating with a projection 122 of the nut 12, so as to assemble the circulation member 11 onto the nut 12. However, once the circulation member 11 is assembled onto the nut 12, the projection 122 cannot be disengaged from the groove 112. Therefore, it will not be easy to disassemble the circulation member 11 from the nut 12 when maintenance of the ball screw is required, or it might need to break the structure in order to disassemble the circulation member 11 from the nut 12. Such a design is likely to cause structural damage when maintenance is performed, increasing the maintenance cost. In addition, machining the projection 122 on the inner surface of the hole 121 of the nut 12 is cost intensive.

Then, a JP 2007-218383 discloses another circulation member 13, as shown in FIGS. 2 and 3, which is defined with a flange 132 around the leg portion 131 thereof, and the flange 132 is to be forced into the nut (not shown). However, when maintenance is performed by disassembling the circulation member 13 from the nut, the flange 132 will be damaged, which will affect the tightness between the circulation member and the nut when they are assembled again.

Finally, as shown in FIGS. 4 and 5, JP 2007-321886 discloses another circulation member 14 disposed on the ball screw, on each of the two leg portions 141 at both ends of the circulation member 14 is disposed an O-ring 15. The arrangement of the O-ring 15 probably facilitates assembly and disassembly of the circulation member 14, however, it cannot solve the problem that the motion of rolling balls 16 will produce vibration of the circulation member 14, and the impacting of the rolling balls 16 will produce noise due to the fact that a return path 17 (as indicated by the arrow) inside the leg portions 141 of the circulation member 14 is connected but not tangent to a loading path 18 (as indicated by the arrow) of the ball screw, as shown in FIG. 5. In other words, when moving in a non-linear manner and passing through the conjunction between the return path 17 and the loading path 18, the rolling balls 16 will collide with one another and will even collide with the circulation member 14, and as a result, the circulation member will vibrate and produce noise. However, the O-ring 15 is too small to reduce the vibration or noise caused, or more precisely, the O-ring 15 is not aimed at noise and vibration reduction.

The present invention has arisen to mitigate and/or obviate the afore-described disadvantages.

### SUMMARY OF THE INVENTION

The primary object of the present invention is to provide a ball screw with a buffering circulation member, wherein the flexible members are disposed at the combining portion between both ends of the circulation member and the through holes of the nut to allow them to be assembled closely with the elastic restoring force of the respective flexible members pressed against the inner surface of the through holes.

Another object of the present invention is to provide a ball screw with a buffering circulation member, wherein the flexible members are disposed at the combining portion between both ends of the circulation member and the through holes of the nut to prevent the circulation member and the nut from being damaged when they are assembled and disassembled.

Another object of the present invention is to provide a ball screw with a buffering circulation member, wherein the flexible members which support the circulation member can absorb or buffer the collision of the rolling elements, thus reducing the vibration of the rolling elements or the noise caused by the collision of the rolling elements.

Yet, another object of the present invention is to provide a ball screw with a buffering circulation member, since the circulation member 40 is made of plastic material, the legs portions 403, 404, 405 and 406 are uniform in thickness and will produce cavities, so that the insertion of the flexible members 70 would improve the part of the strength, while preventing that the noise would be magnified due to the cavity effect.

A further object of the present invention is to provide a ball screw with a buffering circulation member, wherein the circulation member are disposed at the combining portion between both ends of the circulation member and the through holes of the nut to provide a dust proof effect.

To achieve the above objects, the ball screw with a buffering circulation member in accordance with the present invention comprises a screw with a rolling groove in its outer surface;

a nut having an inserting hole for insertion of the screw, in an inner surface of the inserting hole being formed a rolling groove for cooperating with the rolling groove of the screw to form a loading path, in an outer surface of the nut being defined two through holes in communication with the rolling groove of the nut;

the circulation member consisting of a first structure and a second structure, the first and second structures being each formed with two leg portions at both ends thereof, respectively, the leg portions of the first and second structures being assembled in pairs and inserted into the two through holes of the nut, so that the first and second structures are assembled to each other to form a circulation path, each of the leg portions of the first and second structures being formed in its outer surface thereof with a groove;

a plurality of rolling elements rolling within the loading path and the circulation path; and

a plurality of flexible members disposed in the grooves on the leg portions of the first and second structures in such a manner that the flexible members will protrude out of the grooves after inserted therein, when the leg portions the first and second structures are inserted into the two through holes of the nut, a part of the respective flexible members that protrudes out of the grooves will be pressed against an inner surface of the through holes, to enable the first and second structures to be assembled to each other in a seamless manner.

### BRIEF DESCRIPTION OF THE DRAWINGS

FIG. 1 is a cross sectional view of a conventional ball screw with a circulation member which is disclosed in JP 2005-61608;

FIG. 2 is a perspective view of a conventional ball screw with a circulation member which is disclosed in JP 2007-218383;

FIG. 3 is an amplified view of a part of FIG. 2;

FIG. 4 is a perspective view of a conventional ball screw with a circulation member which is disclosed in JP 2007-321886;

FIG. 5 shows the moving route of the rolling elements of FIG. 4;

FIG. 6 is an exploded view of a ball screw with a circulation member in accordance with the present invention;

FIG. 7 is an assembly view of the ball screw with a circulation member in accordance with the present invention;

FIG. 8 is an assembly view of the present invention showing the circulation member and flexible members, wherein the dotted line shows the circulation path;

FIG. 9 shows that the circulation path and the loading path of the present invention are tangent to each other;

FIG. 10 is an exploded view of the present invention showing the circulation member and the flexible members;

FIG. 11 is an assembly view of the present invention showing the circulation member and the flexible members;

FIG. 12 is a cross sectional view of the ball screw with a circulation member in accordance with the present invention; and

FIG. 13 is an assembly view of another embodiment of the present invention showing the circulation member and flexible members, wherein the dotted line shows the circulation path.

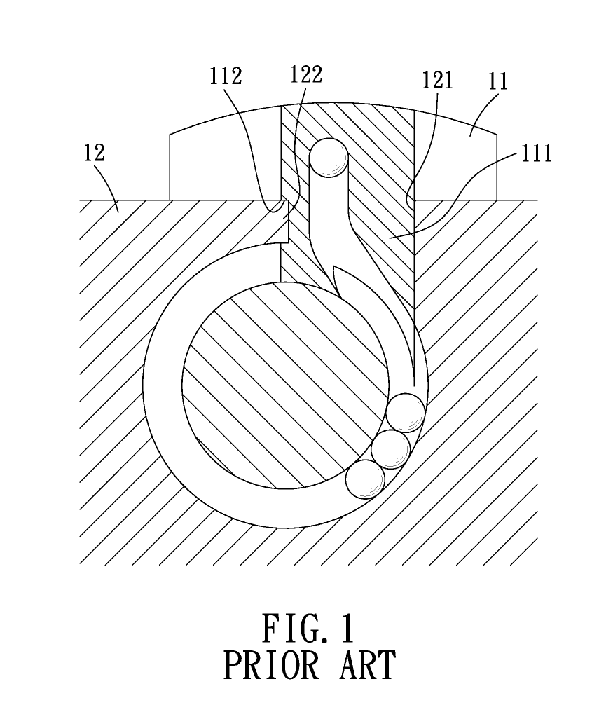

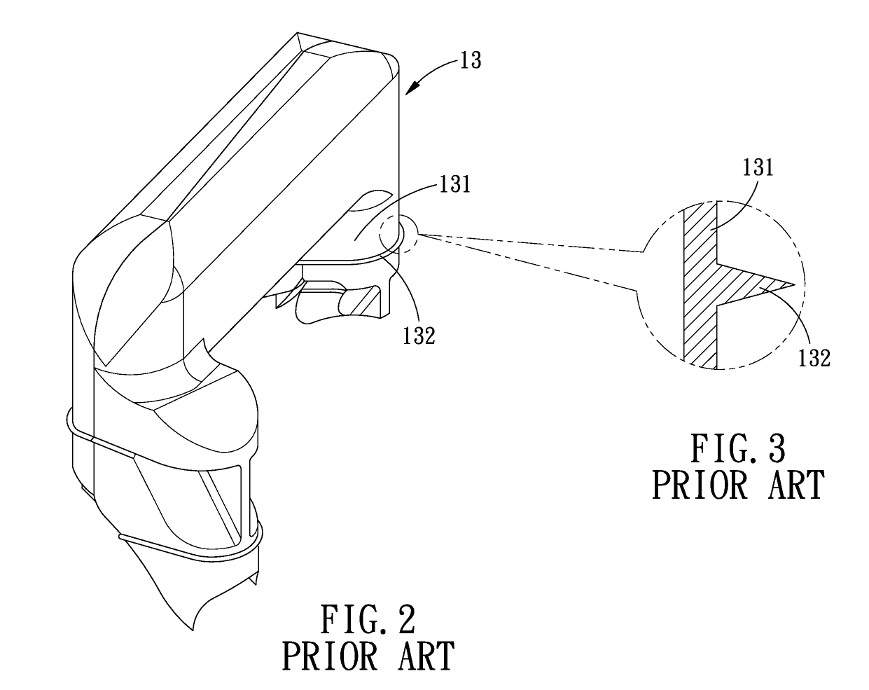

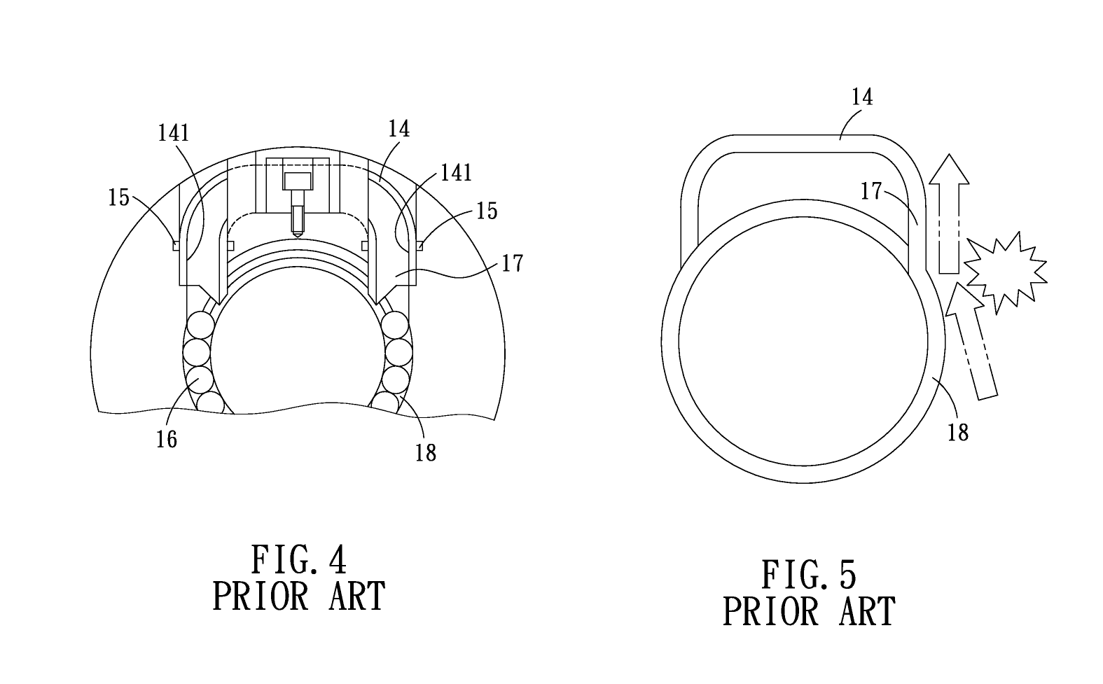

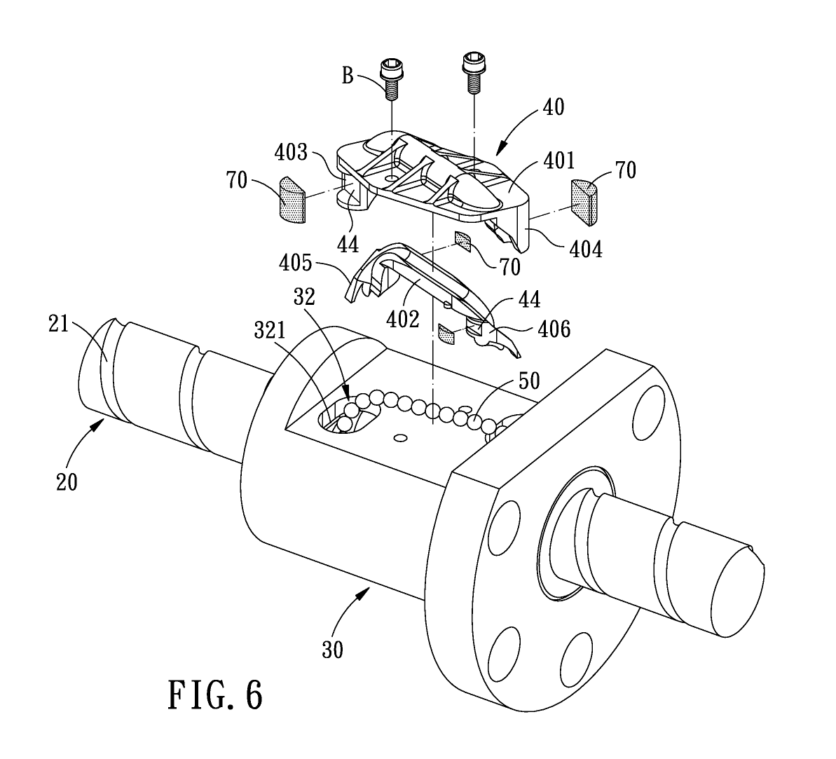

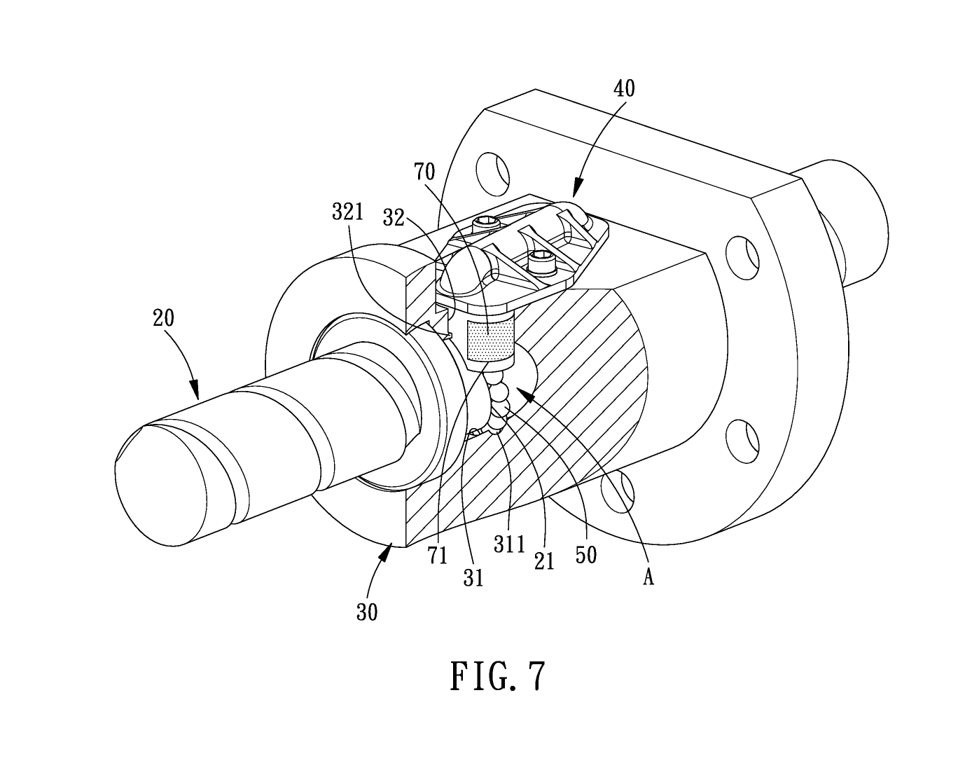

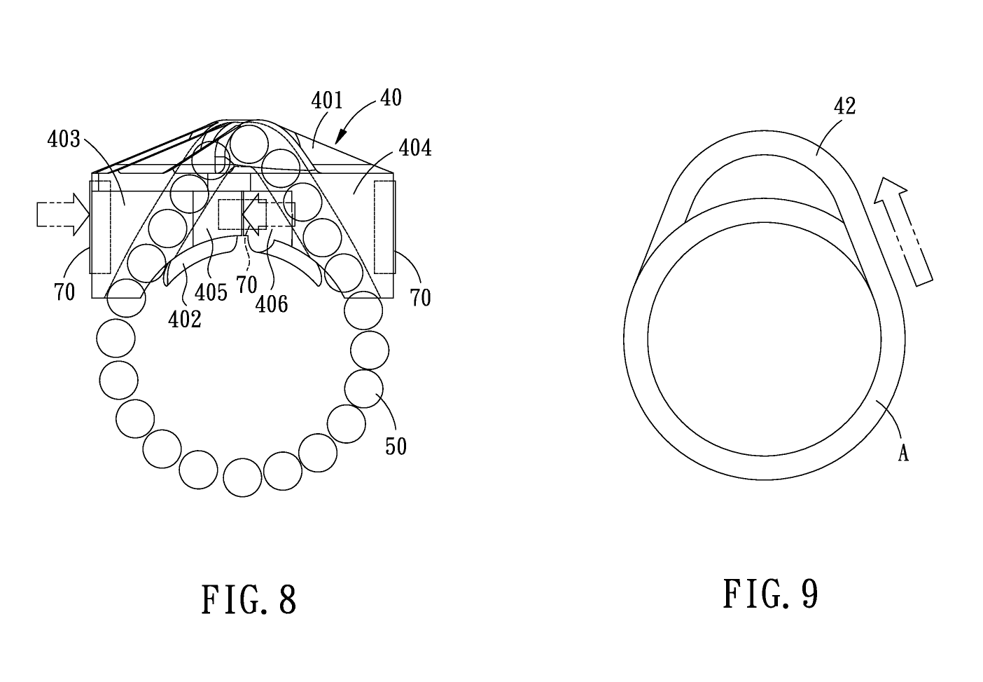

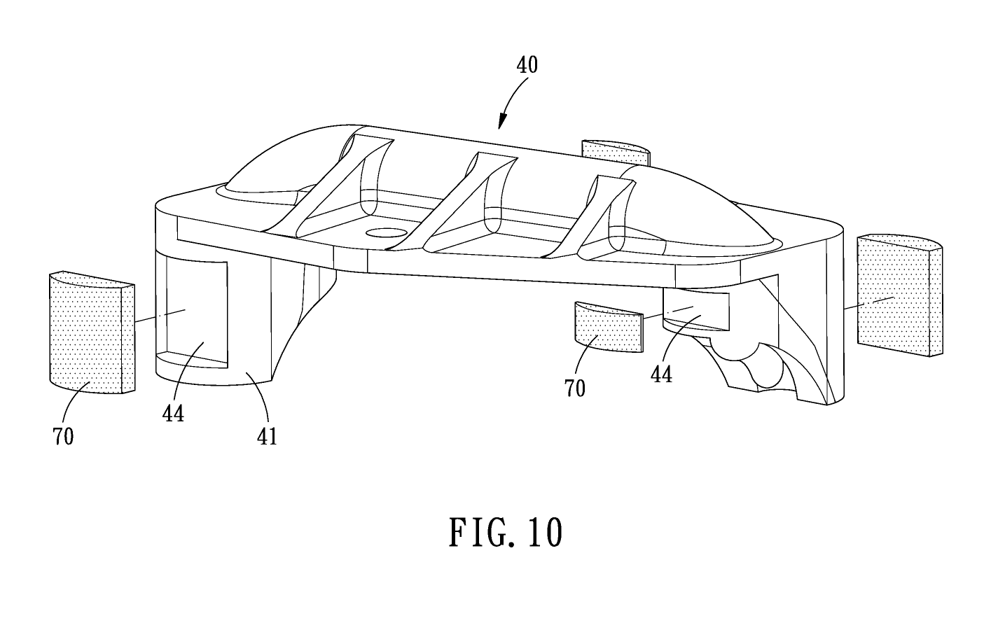

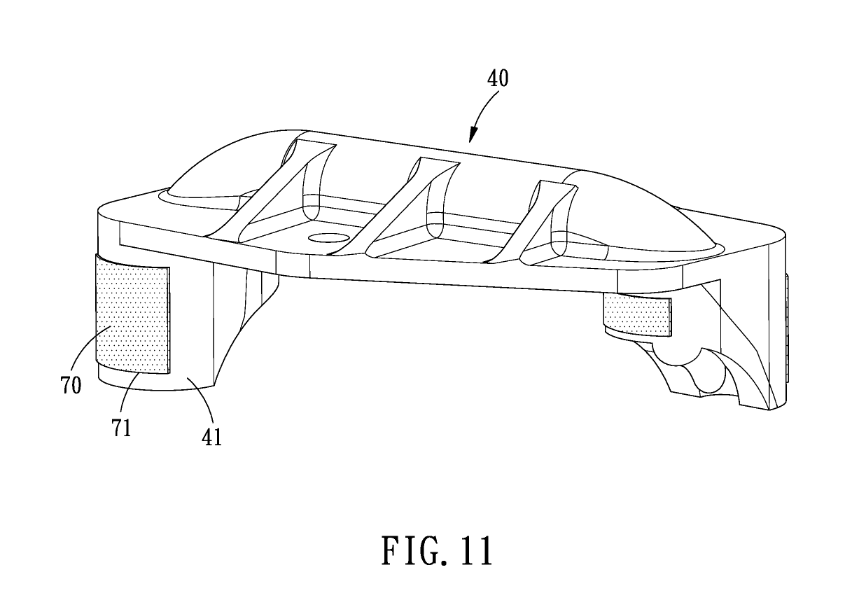

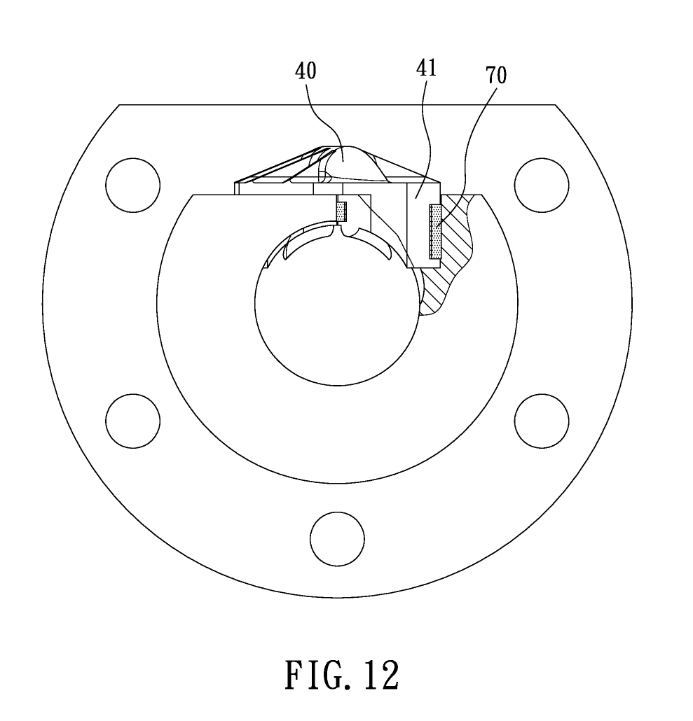

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

Referring to FIGS. 4 and 5, a ball screw with a circulation member in accordance with the present invention comprises: a screw 20, a nut 30, a circulation member 40, a plurality of rolling elements 50 and a plurality of flexible members 70.

The screw 20 is defined in its outer surface with a rolling groove 21.

The nut 30 is provided with an inserting hole 31 for insertion of the screw 20, in the inner surface of the inserting hole 31 is defined a rolling groove 311 for cooperating with the rolling groove 21 to define a loading path A, in the outer surface of the nut 30 are defined two through holes 32 in communication with the rolling groove 311, and in each of the through holes 32 is defined an annular inner flange 321.

The circulation member 40 comprises a first structure 401 and a second structure 402 assembled to each other. The first and second structures 401, 402 are each formed with a leg portion 403, 404, 405 and 406 at both ends thereof, respectively. The leg portions 403 and 404 at both ends of the first structure 401 can be assembled to the leg portions 405 and 406 at both ends of the second structure 402, and then after assembled together, the leg portions 403, 404, 405 and 406 of the first and second structures 401, 402 are inserted into the two through holes 32 of the nut 30, so that the first and second structures 401, 402 are assembled to each other to form a circulation path 42. Besides, each of the leg portions 403, 404, 405 and 406 of the first and second structures 401, 402 is formed on its outer surface thereof with a groove 44, and the grooves 44 of this embodiment are square and arranged in pairs. The circulation member 40 is finally fixed to the nut 30 by two screws B.

The plurality of rolling elements 50 roll within the loading path A and the circulation path 42.

The plurality of flexible members 70 (there are four flexible members 70 in total in this embodiment) are disposed in the grooves 44 on the leg portions 403, 404, 405 and 406 of the first and second structures 401, 402 in such a manner that the flexible members 70 will protrude out of the grooves 44 after received therein, in other words, the thickness of the flexible members 70 is bigger than the depth of the respective grooves 44. Therefore, when the leg portions 403, 404, 405 and 406 of the first and second structures 401, 402 are inserted into the two through holes 32 of the nut 30, the part of the respective flexible members 70 that protrudes out of the grooves 44 would be pressed against the inner surface of the through holes 32, so that the elastic restoring force of the flexible members 70 ensures that the first and second structures 401, 402 can be more closely assembled to each other in a seamless manner. It is to be noted that each of the flexible members 70 will slightly deform because of being pressed and squeezed by the leg portions 403, 404, 405 and 406 of the circulation member 40 and the inner surface of the through holes 32 of the nut 30, thus facilitating stable assembly therebetween, and because the bottom surface 71 of the respective flexible members 70 is abutted against the annular inner flange 321 of the through holes 32 of the nut 30.

Furthermore, in order to reduce the collision-caused noise during the rolling of the rolling elements 50, the circulation path 42 formed by the leg portions 403, 404, 405 and 406 of the first and second structures 401, 402 is connected and tangent to the loading path A (as shown in FIG. 9), in other words, the circulation path 42 is connected to the loading path A in a linear fashion, namely, the conjunction between circulation path 42 and the loading path A is straight but not curved.

It is understood from the above description of the structures of the main parts of the embodiment and the assembly relations among them that the first embodiment of the present invention has the following advantages:

1, Since the flexible members 70 are disposed between the legs portions 403, 404, 405 and 406 of the circulation members 40 and the inner surface of the through holes 32 of the nut 30, plus it is deformable, the circulation member 40 and the nut 30 can be assembled together more closely and tightly, creating a liquid-proof and anti-dust effect, namely, the oil inside the ball screw won't come out from the combining portion between the circulation members 40 and the nut 30, and foreign bodies from outside cannot enter the nut via this combining portion.

2, since the circulation member 40 and the nut 30 are assembled via the flexible and deformable members 70, in assembly, they can squeeze the flexible and deformable members 70 to make the assembly easier, similarly, will also make the disassembly easier, thus preventing the circulation member 40 and the nut 30 from being damaged when they are assembled and disassembled.

3, the flexibility and deformability of the flexible members 70 can absorb the shocks caused by the rolling elements 50 between the circulation member 40 and the nut 30, thus allowing the work platform of the processing machine carrying this ball screw to move more stably.

4. since the circulation member 40 is made of plastic material, the legs portions 403, 404, 405 and 406 are uniform in thickness and will produce cavities, so that the insertion of the flexible members 70 would improve the part of the strength, while preventing that the noise would be magnified due to the cavity effect.

A ball screw with a circulation member in accordance with a second embodiment of the present invention also comprises: a screw, a nut, a circulation member, a plurality of rolling elements and two flexible members, and they generally are assembled in the same manner and provide the same function as the first embodiment, except the following differences:

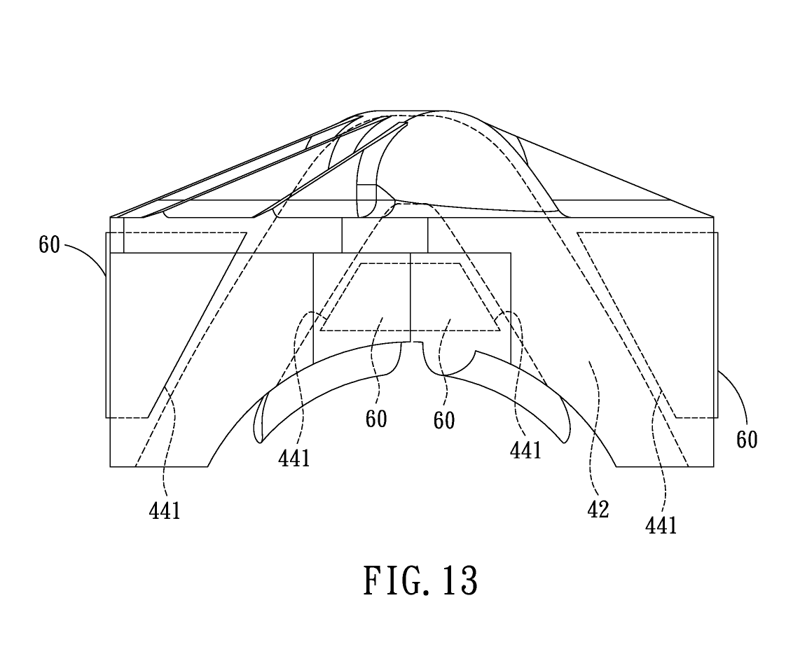

As shown in FIG. 13, the bottoms 441 of the grooves 44 of in the outer surface of the leg portions 403, 404, 405 and 406 of the first and second structures 401, 402 are parallel to the circulation path 42, so that the grooves 44 are relatively large in volume to accommodate relatively large flexible members 60, thus providing a better vibration and noise absorbing effect.

While we have shown and described various embodiments in accordance with the present invention, it is clear to those skilled in the art that further embodiments may be made without departing from the scope of the present invention.

What is claimed is:

1. A ball screw with a buffering circulation member, comprising:
a screw with a rolling groove in its outer surface;
a nut having an inserting hole for insertion of the screw, in an inner surface of the inserting hole being formed a rolling groove for cooperating with the rolling groove of the screw to form a loading path, in an outer surface of the nut being defined two through holes in communication with the rolling groove of the nut;
the circulation member consisting of a first structure and a second structure, the first and second structures being each formed with two leg portions at both ends thereof, respectively, the leg portions of the first and second structures being assembled in pairs and inserted into the two through holes of the nut, so that the first and second structures are assembled to each other to form a circulation path, each of the leg portions of the first and second structures being formed in its outer surface thereof with a groove;
a plurality of rolling elements rolling within the loading path and the circulation path; and
a plurality of flexible members disposed in the grooves on the leg portions of the first and second structures in such a manner that the flexible members will protrude out of the grooves after inserted therein, when the leg portions the first and second structures are inserted into the two through holes of the nut, a part of the respective flexible members that protrudes out of the grooves will be pressed against an inner surface of the through holes, to enable the first and second structures to be assembled to each other in a seamless manner.

2. The ball screw with a buffering circulation member as claimed in claim 1, wherein the circulation path formed by the leg portions of the first and second structures is connected and tangent to the loading path.

3. The ball screw with a buffering circulation member as claimed in claim 1, wherein each of the through holes is defined on its inner surface with an annular inner flange against which a bottom surface of the respective flexible members is abutted.

4. The ball screw with a buffering circulation member as claimed in claim 1, wherein the grooves at both ends of the first structure are located correspondingly to the grooves at both ends of the second structure, and all the grooves are square.

5. The ball screw with a buffering circulation member as claimed in claim 1, wherein bottoms of the grooves of in the outer surface of the leg portions of the first and second structures are parallel to the circulation path.
